(19) United States
(12) Patent Application Publication
(10) Pub. No.: US 2017/0146076 A1
(43) Pub. Date: May 25, 2017

(54) Hydraulic Circuit for Clutch Actuation

(71) Applicant: Caterpillar Inc., Peoria, IL (US)

(72) Inventors: Brian E. Lister, Edwards, IL (US); Timothy A. Lorentz, Morton, IL (US)

(73) Assignee: Caterpillar Inc., Peoria, IL (US)

(21) Appl. No.: 14/949,007

(22) Filed: Nov. 23, 2015

(51) Int. Cl. F16D 48/02; F16D 13/52

(52) U.S. Cl. CPC F16D 25/14; F16D 13/52

(57) ABSTRACT

A hydraulic circuit includes a clutch actuator operatively with a clutch that may be disposed in a transmission. A hydraulic fluid source supplies pressurized hydraulic fluid for the clutch actuator. An on-off valve is disposed in fluid communication between the clutch actuator and the hydraulic fluid source; the on-off valve configured to fill the clutch actuator with hydraulic fluid. An accumulator is disposed in parallel with the on-off valve and in fluid communication with the clutch actuator. The accumulator is adapted to receive hydraulic fluid redirected from the clutch actuator and to provide a counter-pressure for modulating the clutch actuator.

### TECHNICAL FIELD

This patent disclosure relates generally to a work machine equipped with one or more clutches for coupling and decoupling rotating elements for power transmission and, more particularly, to a hydraulic circuit and method for engaging and disengaging the clutches.

### BACKGROUND

In various types of work machines, in order to transmit power in the form of rotational motion generated by a prime mover such as an internal combustion engine to a driven element, which may be a rotatable wheel or other propulsion device associated with the machine, a powertrain operatively links the engine and driven element. The powertrain itself may include components such as a transmission to adjust and change the torque and/or speed characteristics of the transmitted power output. Transmissions include a plurality of gears that can be selectively engaged in different ratios to increase or decrease the rotational speed and, in an inverse relation, the torque transmitted through the powertrain. The gear ratios may include a forward-neutral-reverse gear as well as a plurality of fixed gear ratios that provide different ranges of speed and torque for the machine. Transmissions may be manual or automatic depending on the level of operator control over the selective shifting between gear ratios.

To switch between gear ratios, some transmissions utilize a hydraulic circuit configured to selectively operate clutches that are associated with the various gears. A standard clutch is a mechanical device in which adjacent rotatable elements coupled to different parts of the powertrain are moved into frictional engagement so that their relative rotational speeds synchronize with each other. In particular, when shifting between gear ratios, an “oncoming clutch” may engage a first pair of gears while an “off-going” clutch may disengage a second pair of gears. The driven gear associated with the oncoming clutch speeds up or down to match the speed of the driving gear. This engagement and disengagement of gears occurs simultaneously to continue power transfer through the transmission without interruption while the transmission attempts to smoothly change the speed and torque ratios.

The hydraulic circuit directs hydraulic fluid to and from the oncoming and off-going clutches to move the elements into and out of frictional engagement.

Transmissions are sometimes calibrated to accommodate the initial speed difference between engaging gears and the inherent time delay in filling and draining hydraulic fluid from the oncoming and off-going clutches. Still, some degree of disruption often occurs during gear shifts, part of which may be caused by improper hydraulic engagement of the clutches. For example, if the oncoming clutch experiences an early fill event, filling too quickly with hydraulic fluid, the transmitted torque may suddenly spike causing the machine to jerk or lurch. Likewise, if the oncoming clutch experiences a late fill event such that the oncoming clutch is unable accepted the full torque transmission before the off-going clutch disengages, the machine may lug or temporarily drag before full torque transmission is restored. Besides being unpleasant for the operator of the machine, the jarring motions may dislodge or spill a load being carried by the machine. The jarring also subjects the components of the transmission to excessive wear and friction.

Machine manufacturers have developed various systems and methodologies to reduce or mitigate the effects of disrupted gear shifts. For example, U.S. Pat. No. 6,640,950 (“the '950 patent”), assigned to the assignee of the present disclosure, describes a method of engaging a clutch associated with a gear by directing hydraulic fluid to the clutch. A control system monitors the hydraulic pressure of the hydraulic fluid flowing to the clutch to determine when the clutch fills with fluid. The control system can thereafter operate the hydraulic circuit in various ways to gradually and smoothly move the rotatable elements of the clutch into full engagement. The present disclosure is directed to similar considerations regarding clutch engagement in a machine.

### SUMMARY

The disclosure describes, in one aspect, a hydraulic circuit for a transmission in a work machine that includes at least one clutch operatively associated with one or more gears in the transmission. The hydraulic circuit has a hydraulic fluid source that supplies pressurized hydraulic fluid for the circuit. The clutch is operatively associated with a clutch actuator having an actuator chamber and an actuator piston movably disposed in the actuator chamber. The clutch actuator in turn is in fluid communication with the hydraulic fluid source. The hydraulic circuit further includes an on-off valve disposed between the clutch actuator and the hydraulic fluid source and configured to selectively establish fluid communication between the clutch actuator and the hydraulic fluid source. An accumulator is disposed downstream of and in fluid communication with the clutch actuator and hydraulic fluid source to provide a counter-pressure to the clutch actuator.

In another aspect, the disclosure describes a method of engaging a clutch associated with a work machine. According to the method, an on-off valve disposed between hydraulic fluid source and a clutch actuator coupled to the clutch is opened to direct pressurized hydraulic fluid to the actuator from a hydraulic fluid source. The on-off valve may also supply pressurized hydraulic fluid from the hydraulic fluid source to an accumulator disposed downstream of the clutch actuator. Once the clutch actuator and the accumulator are full, a counter-pressure is applied via the accumulator to counter the pressurized hydraulic fluid in the accumulator volume. The method allows for modulating the counter-pressure to modulate hydraulic pressure in the clutch actuator to thereby modulate the clutch.

In yet a further aspect, the disclosure describes a hydraulic circuit for actuating a clutch operatively associated with a hydraulic actuated clutch actuator. The hydraulic circuit includes an on-off valve in fluid communication with and disposed between the clutch actuator and a hydraulic fluid source that supplies pressurized hydraulic fluid. The on-off valve is adapted to fill the clutch actuator with pressurized hydraulic fluid. The hydraulic circuit also includes an accumulator disposed in parallel with the on-off valve and in fluid communication with the clutch actuator. The accumulator is adapted to modulate hydraulic pressure in the clutch actuator.

### BRIEF DESCRIPTION OF THE DRAWINGS

FIG. 1 is a schematic representation of a machine including a transmission having a plurality of gears and clutches that is disposed between an internal combustion engine and a driven element.

FIG. 2 is a schematic representation of a hydraulic circuit operatively associated with a clutch for engaging or disengaging a gear of the transmission including a clutch actuator, an accumulator, and an on/off valve arranged in accordance with the present disclosure.

FIG. 3 is a chart illustrating the different hydraulic conditions associated with the components of the hydraulic circuit of FIG. 2 during different stages of a gear shift event.

### DETAILED DESCRIPTION

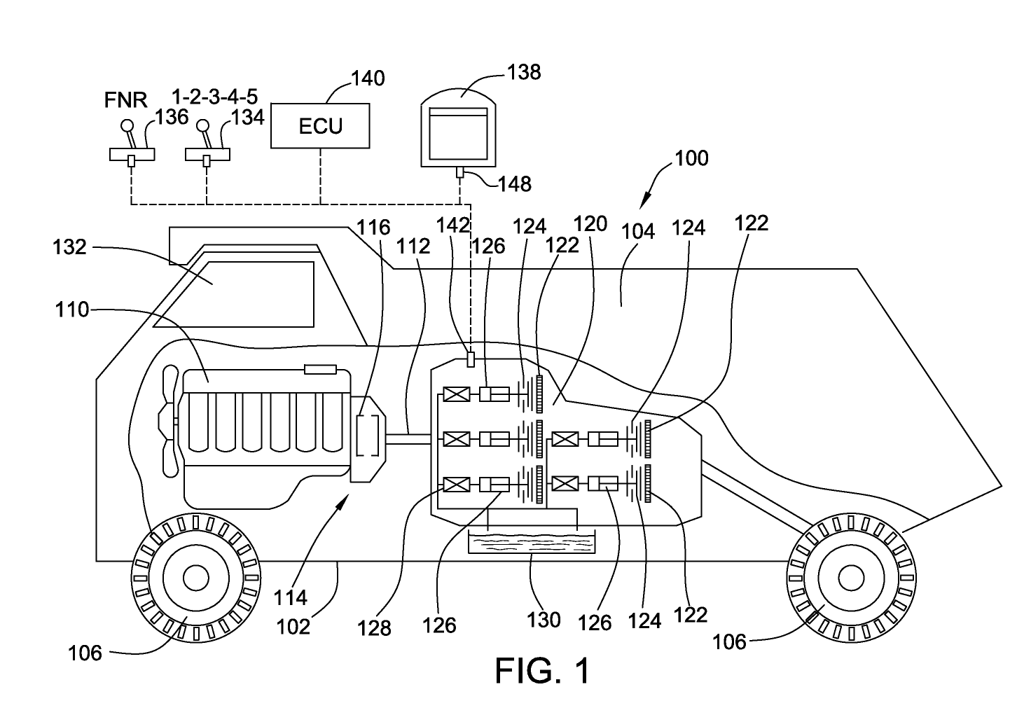

Now referring to the drawings, wherein like reference numbers refer to like elements, there is illustrated in FIG. 1 an embodiment of a work machine 100 for performing various tasks or operations about a worksite such as a construction site, a mining site, or an agricultural location. While the particular machine 100 illustrated in connection with FIG. 1 is a dump truck for transporting loose material such as gravel, earth, or dirt, the arrangement disclosed herein has universal applicability in various other types of machines as well. The term “machine” may refer to any machine that performs some type of operation associated with an industry such as mining, construction, farming, transportation, or any other industry known in the art. For example, the machine may be an earth-moving machine, such as a wheel loader, excavator, dump truck, backhoe, motor grader, material handler or the like. Moreover, an implement may be connected to the machine. Such implements may be utilized for a variety of tasks, including, for example, loading, compacting, lifting, brushing, and include, for example, buckets, compactors, forked lifting devices, brushes, grapples, cutters, shears, blades, breakers/hammers, augers, and others.

The machine 100 in the form of a dump truck can include a body or frame 102 and a dump body 104 for hauling and dumping material that may be tilted with respect to the frame. To propel the machine 100 about the worksite, the frame 102 can be supported on a plurality of wheels 106 which may include drive wheels and steer wheels that are in rolling contact with the ground, however, in other embodiments, it should be appreciated that the machine may utilize other types of propulsion devices such as continuous tracks or the like. In addition to the dump body 104 and the wheels 106, the machine 100 may be operatively associated with other suitable types of driven elements via a power takeoff for accomplishing various tasks. To provide motive power for the machine 100, the machine may include a prime mover such as an internal combustion engine 110 that can combust a hydrocarbon-based fuel and convert the chemical energy therein to rotational motion that spins a driveshaft 112 thereby generating rotational torque. The internal combustion engine 110 may be a diesel burning compression ignition engine, a gasoline burning spark ignition engine, a gas-burning turbine, hybrid engine or any other suitable power source. To transmit the rotational power from the driveshaft 112 associated with the internal combustion engine 110 to the wheels 106 and other driven elements associated with the machine 100, a drive train or powertrain 114 can be supported within the frame 102 that includes power transmitting components such as additional shafts, clutches, torque convertors, differentials, axels, and the like. For example, to selectively couple and decouple the internal combustion engine 110 with the driveshaft 112, a coupling clutch 116 can be associated with the output of the engine. The coupling clutch 116 can selectively connect and disconnect the driveshaft 112 with the crankshaft rotationally disposed in the internal combustion engine 110 so that the two components are locked in rotation together.

To modify the rotational speed and/or torque being output by the internal combustion engine 110, the powertrain 114 may also be associated with a transmission 120 disposed between the driveshaft 112 and the other driven elements including the wheels 106. The transmission 120 may be a multispeed transmission having a plurality of selectively engagable frictional elements such as a plurality of interacting gears 122. The plurality of gears 122 can be arranged in selected pairs or groups and can be engaged by intermeshing their teeth together. The diameter of the gears and the number and spacing between the teeth determines the gear ratio of a particular set of engaged gears with the different gear ratios either increasing or decreasing the rotational speed output from the internal combustion engine. The gear ratio is directly related to the speed ratio of the transmission which defines the increase or decrease in rotational speed between the driveshaft 112 and the output of the transmission. Because the speed ratio is typically calculated as input speed/output speed, at least with respect to machine speed, the speed ratio has an inverse relation to the machine speed, with a decrease in speed ratio corresponding to an increase in machine speed and an increase in speed ratio corresponding to a decrease in machine speed. The gear ratio or speed ratio can also define, in an inverse relationship, the change in output torque caused by the transmission. The transmission 120 can include any suitable number of predefined, selectable gear ratios. Further, the transmission 120 can also include a gear combination that reverses the rotational direction of the driveshaft 112 output from the internal combustion engine 110.

The transmission 120 may be a synchronous transmission wherein the gear combinations that make up the predetermined gear ratios are continuously meshed together and one or more clutches are used to bring selected gear ratios into and out of fixed engagement with rotating shafts in the transmission that couple the crankshaft and the driveshaft 112. Accordingly, in the illustrated embodiment, the plurality of gears 122 that make up the gear ratios can be operatively associated with a plurality of clutches 124. The gears 122 and associated clutches 124 may be present in the same or different ratios so that each clutch 124 may be associated with more than one gear. The plurality of clutches 124 can be hydraulic clutches that are engaged or released by controlling pressure of a hydraulic fluid supplied to the respective clutch. In particular, the clutches 124 can be formed from a plurality of adjacent plates that can be moved into and out of frictional contact with each other. When pressed adjacent to each other, the plates of the clutch 124 transmit the rotational power through the transmission 120 while when moved apart the plates are able to rotate relative one another. To actuate the clutches 124, each clutch can be operatively associated with a clutch actuator 126 and one or more hydraulic valves 128 that directs hydraulic fluid into or out of the clutch actuator. The clutch actuator 126 and the hydraulic valve 128 are operatively associated with a hydraulic system or hydraulic circuit 130 disposed on the machine 100 as described in more detail below. When shifting up or down gear ratios, the hydraulic actuator 126 associated with one set of clutches 124 is pressurized to engage an unengaged gear ratio while a clutch actuator 126 associated with second set of clutches is simultaneously depressurized to disengage an engaged gear ratio. The first set may be referred to as the on-coming clutches and the second set may be referred to as the off-going clutches.

To accommodate an operator of the machine 100, an operator's station or operator's cab 132 may be disposed on the frame 102 forward of the dump body 104. The operator's cab 132 may further accommodate various controls the operator can use to direct operation of the machine 100. For example, to shift the gears 122 associated with the transmission 120 up or down, a gear shifter or gear selector 134 can be operatively associated with the power train 114 and the hydraulic circuit 130 to control engagement or disengagement of selected clutches 124. The gear selector 134 and relatedly the transmission 120 can have any number of engagable gears appropriate for the intended application of the machine such as, for example five different gear speeds, eight different gear speeds, or any other variation. In addition to the gear selector 134, the powertrain 114 may also be operatively associated with a forward-neutral-reverse (F-N-R) selector 136 that can decouple the internal combustion engine 110 from the rest of the driveshaft 112 by, for example, releasing the coupling clutch 116. The F-N-R selector 136 can also engage and disengage specific gear ratios that reverse the rotational motion being applied to the driveshaft 112 by the internal combustion engine 110. Although in the illustrated embodiment the gear selector 134 and F-N-R selector 136 are illustrated as levers, in other embodiments they can be other suitable controls such as buttons. In addition, to further interface with the operator of the machine 100, a human-machine interface 138 including an operator display panel such as a LCD screen or the like to display information about the machine can be included. The gear selector 134, F-N-R selector 136, and the human-machine interface 138 can be disposed in the operator station 132 with the other inputs for controlling the machine 100 such as the steering mechanism and an accelerator. However, in those embodiments in which the machine is controlled remotely, the gear selector 134, F-N-R selector 136, and the human-machine interface 138 can likewise be located off the machine.

To coordinate and control the various components in the powertrain 114, the machine 100 may include an electronic controller or computerized control module, or electronic control unit (“ECU”) 140, as referred to herein. The ECU 140 may be adapted to monitor various operating parameters and to responsively regulate various variables and functions affecting the powertrain. The ECU 140 may include a microprocessor, an application specific integrated circuit (ASIC), or other appropriate circuitry and may have memory or other data storage capabilities. The ECU can include or be programmed with functions, steps, routines, control maps, data tables, charts and the like saved in and executable from read-only memory or another electronically accessible storage medium to control the engine system. Storage or computer readable mediums may take the form of any media that provides instructions to the controller for execution. The mediums may take the form of non-volatile media, volatile media, and transmission media. Non-volatile media includes, for example, optical or magnetic disks. Volatile media includes dynamic memory. Transmission media includes coaxial cables, copper wire and fiber optics, and may also take the form of acoustic or light waves, such as those generated during radio-wave and infra-red data communications. Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave or any other medium from which a computer or processor may read.

Although in FIG. 1, the ECU 140 is illustrated as a single, discrete unit, in other embodiments, the ECU and its functions may be distributed among a plurality of distinct and separate components. To receive operating parameters and send control commands or instructions, the controller may be operatively associated with and may communicate with various sensors and controls in the operator station 132 and associated with the various components in the powertrain 114. Communication between the controller and the sensors and controls may be established by sending and receiving digital or analog signals across electronic communication lines or communication busses. The various communication and command channels are indicated in dashed lines for illustration purposes. To control and direct the configuration of the transmission 120, including the engagement and disengagement of specific gears 122, the ECU 140 can communicate with a transmission control 142 operatively associated with the transmission. The ECU may also measure rotational speeds input to and output from the transmission 120 via magnetic pickup sensors, optical sensors and the like. To enable operator adjustment of the transmission settings, the ECU 140 can communicate with a gear selector sensor 144 and a direction selector sensor 146 associated with the respective gear selector 134 and direction selector 136 disposed in the operator station 132. The ECU 140 can also communicate with the human-machine interface 138 via a display control 148 to interface with the operator. Command signals received from those controls can be processed by the controller and transmitted to the transmission control 142 to adjust the transmission settings accordingly.

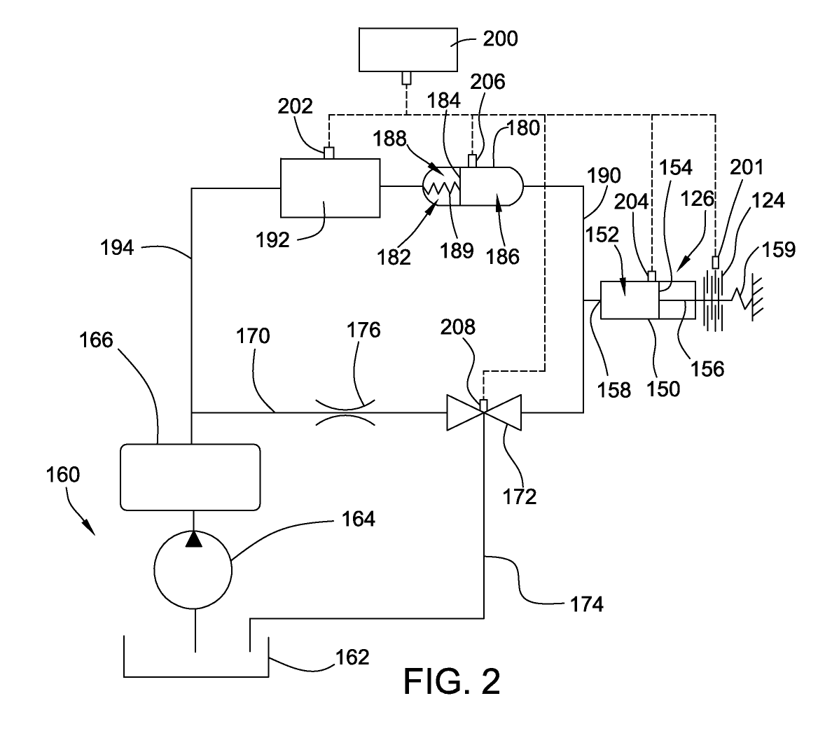

Referring to FIG. 2, there is illustrated a schematic representation of the hydraulic circuit 130 arranged to engage and disengage the clutch 124 disposed in the transmission and associated with at least one gear ratio. To actuate the clutch 124 by moving the adjacent plates of the clutch into or out of frictional contact with one another, the clutch actuator 126 can be physically configured to urge the plates together and apart by the application of hydraulic pressure. In particular, the clutch actuator 126 can take the form of a hydraulic cylinder having a tubular cylinder body 150 delineating an actuator chamber 152 and an actuator piston 154 slidably disposed therein with a piston rod 156 that extends partially from a head end the cylinder body 150. When the actuator piston 154 reciprocally moves back and forth within the actuator chamber 152, the piston rod 156 extends and retracts from the cylinder body 150. The cylinder body 150 can further be configured with a cap end delineating an actuator inlet 158 that can be coupled to a hydraulic hose or tubing to establish fluid communication with the hydraulic circuit 130. It can be appreciated that as pressurized hydraulic fluid enters the actuator chamber 152 from the actuator inlet 158, the actuator piston 154 is moved to the right thereby urging the piston rod 156 against the plates of the clutch 124. In an embodiment, to maintain a normally disengaged configuration for the clutch 124 with the plates spaced apart, an actuator spring 159 can be disposed on the side of the clutch opposite the clutch actuator 126. The actuator spring 159 can be a helical compression spring and is connected to the piston rod 156 and arranged to urge the actuator piston 154 in the actuator chamber 152 toward the actuator inlet 158. Hence, if the hydraulic circuit 130 does not apply sufficient hydraulic pressure to the actuator inlet 158 to overcome the spring rate of the actuator spring 159, the actuator spring 159 can discharge any hydraulic fluid present in the actuator chamber 152 via displacement of the actuator piston 154. While the foregoing embodiment of the clutch actuator 126 is a single acting cylinder, in other embodiments, the clutch actuator can have other configurations such as a double acting cylinder.

To supply hydraulic fluid for actuating the clutches 124, the hydraulic circuit 130 associated with the transmission can include a hydraulic fluid source 160. To store hydraulic fluid, the hydraulic fluid source 160 may include a vented reservoir 162 designed as a refillable fluid tank and vented to atmospheric pressure. The vented reservoir 162 may be disposed at a low location relative to the arrangement of the hydraulic circuit 130 so that it may function as a sump for low pressure hydraulic fluid returning from the circuit. To pressurize and direct the hydraulic fluid in the vented reservoir 162 to the clutches 124, the hydraulic circuit 130 can include a hydraulic pump 164 disposed in fluid communication with the vented reservoir. The hydraulic pump 164 can be any suitable type of pump for pressurizing and displacing fluids including a piston pump, a vane pump, a gear pump or the like, and may have a fixed or variable displacement. In an embodiment, to temporarily store pressurized hydraulic fluid, the hydraulic circuit may further include a pressurized reservoir 166 in communication with and downstream of the hydraulic pump 164. The pressurized reservoir 166 can function as a plenum, containing the hydraulic fluid at elevated pressures, and can serve to equalize pressure fluctuations and ensures an adequate supply of hydraulic fluid for the applications associated with the hydraulic circuit. The pressurized reservoir can supply hydraulic fluid to additional clutches and applications in the hydraulic circuit.

To direct pressurized hydraulic fluid to the clutch actuator 126, the pressurized reservoir 166 can be in fluid communication with a supply conduit or supply line 170, such as a flexible hosing or rigid tubing, that extends to the actuator inlet 158. To adjustably control flow of pressurized fluid in accordance with the selective engagement and disengagement of the clutches 124, the hydraulic circuit 130 may include various components disposed in the supply line 170. For example, an on-off valve 172 can be disposed between the hydraulic fluid source 160 and the clutch actuator 126. The on-off valve 172 may be configurable between an opened positioned and a closed position to selectively establish fluid communication with the clutch actuator 126. The on-off valve 172 may be any suitable style of hydraulic valve and can be actuated by any suitable method. In the illustrated embodiment, the on-off valve 172 may be a three-way valve that is operatively associated with a relief line or return line 174 that is directed back to and communicates with the vented reservoir 162 of the hydraulic circuit 130. Accordingly, to disengage the clutch 124, the on-off valve 172 redirects hydraulic fluid from the clutch actuator 126 to the vented reservoir 162 via the return line 174 thereby allowing the clutch plates to move apart. To further regulate the flow rate of pressurized hydraulic fluid through the on-off valve 172 and the clutch actuator 126, an orifice or supply restrictor 176 can be disposed in the supply line 170 between the pressurized reservoir 166 and the on-off valve. The supply restrictor 176 may be sized in comparison to the actuator chamber 152 to regulate the fill rate and actuation timing of the clutch actuator 126.

To enable further regulation over operation of the clutch actuator 126, and therefore control over the clutch 124, the hydraulic circuit 130 can include an accumulator 180 disposed downstream of and in fluid communication with the actuator and the hydraulic fluid source 160 disposed upstream thereof. The accumulator 180 is a pressure storage reservoir for hydraulic fluid under pressure for subsequent use. In the illustrated embodiment, the accumulator can be a double acting cylinder including an enclosed accumulator chamber 182 and an accumulator piston 184 slidably disposed and reciprocally movable within the tubular accumulator chamber. The accumulator piston 184 separates the accumulator chamber 182 between a front chamber 186 and a back chamber 188. Reciprocal movement of the accumulator piston 184 acts to expand and reduce the relative volumes of the front and back chambers 186, 188. The accumulator 180 can further include an accumulator spring 189 disposed in the back chamber 188 and arranged to urge the accumulator piston 184 toward or through the front chamber 186. In other embodiments, however, the accumulator 180 may assume different designs or types such as, for example, a gas charged design. To establish fluid communication between the accumulator 180 and the clutch actuator 126, an accumulator line 190 such as hosing or tubing extends between the front chamber 186 and the actuator inlet 158. In the illustrated configuration, the accumulator 180 and the on-off valve 172 are in parallel with respect to the clutch actuator 126.

The accumulator 180 can be configured to provide a counter-pressure to the hydraulic circuit 130 that assists filling of the clutch actuator 126 with pressurized hydraulic fluid. In particular, because of its downstream position within the hydraulic circuit 130, the front chamber 186 can receive pressurized hydraulic fluid discharged or redirected from the clutch actuator 126 if the fluid is under sufficient pressure to overcome the spring rate associated with the accumulator spring 189. Hence, the actuator spring 159 and the accumulator spring 189 can be comparatively configured to, in part, determine the relative fill rates and times of the actuator chamber 152 and the accumulator chamber 182 and maintain the relative fluid pressure in the chambers that are in fluid communication with each other. More specifically, the spring rates of the actuator and accumulator springs 159, 189 and the relative fluid volumes of the clutch actuator 126 and accumulator 180 can be selected to regulate flow of pressurized hydraulic fluid between the components and thereby the relative displacement of the pistons therein.

To take additional advantageous use of the counter-pressure, the accumulator 180 can be operatively associated with a counter-pressure control valve 192. In particular, the counter-pressure control valve 192 can be disposed in fluid communication with the back chamber 188 of the accumulator 180 and can supply fluid pressure to assist the accumulator spring 189 urging the accumulator piston 184 toward or away from the front chamber 186. To provide the added fluid pressure, the counter-pressure control valve 192 can be in fluid communication with the pressurized reservoir 166 of the hydraulic fluid source 160 via a counter-pressure line 194, although in other embodiments, the added pressure may be provided through other sources or may be generated by the counter-pressure control valve through other methods. In various embodiments, to vary the pressure and/or flow rate of the pressurized hydraulic fluid directed to the back chamber 188 of the accumulator 180, the counter-pressure control valve 192 can be a proportional valve having an adjustable configuration and can be physically designed as a needle valve, a spool valve, or any other suitable style of valve. In an embodiment, to increase the available counter-pressure, a pressure compounder such as an auxiliary pump can be disposed in the counter-pressure line 194 to boost the hydraulic pressure from the hydraulic fluid source 160.

To control operation of the components of the hydraulic circuit 130, a hydraulic control unit 200 can be arranged in electronic communication with the hydraulic components. In an embodiment, the hydraulic control unit 200 can be associated with or part of the ECU 140 described with respect to FIG. 1 and can be configured to send and receive non-transitory electronic signals via data buses or communication lines indicated in dashed lines and can be programmed to execute instructions to perform functions, routines, steps and like. In particular, to assess the operating conditions of the clutch 124, such as whether the clutch plates are slipping or synchronized, the hydraulic control unit 200 can communicate with a clutch sensor 201 operatively associated with the clutch to measure relative rotational speed of the plates. To control the generation of the counter-pressure, the hydraulic control unit 200 can be in communication with a control valve controller 202 operatively associated with the counter-pressure control valve 192 to open, close, or adjust the flow rate and pressure of hydraulic fluid through the control valve. To measure the operative parameters and ongoing performance of the clutch actuator 126 and the accumulator 180, the hydraulic control unit 200 can be associated with an actuator controller 204 and an accumulator controller 206 respectively. The actuator controller 204 and accumulator controller 206 may relay information about the piston displacement or fluid pressure within the respective components. To connect and disconnect the clutch actuator 126 and the accumulator 180 with the hydraulic fluid source 160, the hydraulic control unit 200 can also communicate with an on-off valve controller 208 operatively associated with and adapted to open and close the on-off valve 172.

### INDUSTRIAL APPLICABILITY

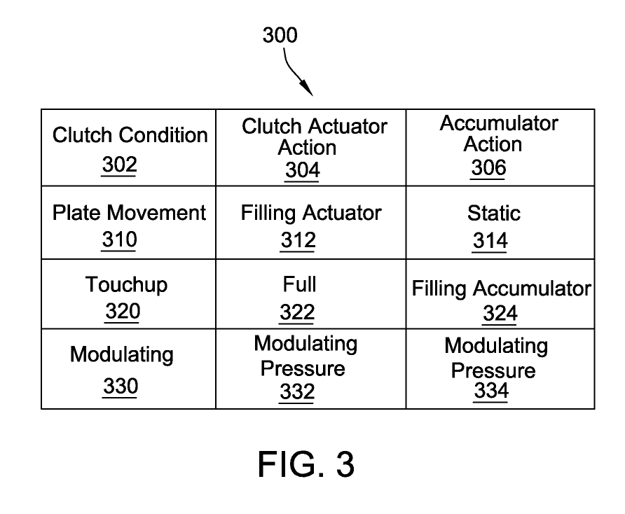

The foregoing arrangement can be utilized to assist the actuation of a clutch 124, whether it is an oncoming or off-going clutch, in particular by accommodating early fill or late fill events that may occur with the clutch actuator 126. This may accomplished by dividing responsibility for the clutch actuation stages between the different components of the hydraulic circuit. For example, referring to FIG. 3, as explained in relation to FIG. 2, there is illustrated a chart 300 depicting the different hydraulic clutch actuation stages that may occur when shifting between gears operatively associated with a clutch. The chart 300 associates the different clutch conditions 302 or stages in relation to the hydraulic activity occurring with respect to the clutch actuator action 304 and the accumulation action 306. Initially, during a plate movement stage 310 where the clutch plates move together, it may be necessary to fill the clutch actuator 126 with hydraulic fluid to prime the actuator for engaging the clutch 124. The plate movement stage 310 is accomplished by opening the on-off valve 172 upstream of the clutch actuator 126 to direct the pressurized hydraulic fluid from the hydraulic fluid source 160 to the actuator and thereby filling the actuator chamber 152 during a filling condition 312. During the plate movement stage 310, the accumulator 180 may or may not receive hydraulic fluid due to its location parallel to the on-off valve 172 and downstream of the clutch actuator 126 and its condition may remain relatively static 314.

As the clutch actuator 126 is filling, the volume of hydraulic fluid entering the actuator chamber 152 displaces the actuator piston 154 so the plates of the clutch 124 move into contact achieving a condition that may be referred to as touchup 320. Touchup 320 may be characterized by significant slippage between the clutch plates as the plates synchronize relative speeds. Because the actuator chamber 152 is relatively full 322, hydraulic fluid is redirected to the accumulator 180 disposed downstream of the clutch actuator 124 so the accumulator status is filling 324. During the touchup stage 320, as the clutch actuator 124 and the accumulator 180 fill with fluid, the on-off valve 172 in combination with the supply restrictor 176 are primarily responsible for directing and controlling the flow rate or volume of hydraulic fluid channeled to those components of the hydraulic circuit 130 and hence timing of the hydraulic stages in the chart 300. The relative displacement of the actuator piston 154 and the accumulator piston 184 may primarily be a result of fluid flow into the clutch actuator and the accumulator. In an embodiment, to ensure the accumulator 180 fills after the clutch actuator 126 is full of hydraulic fluid, the spring rate of the accumulator spring 189 can be equal to or higher than the actuator spring 159 of the actuator.

Subsequent to the touchup stage 320, the clutch 124 may enter a modulating stage 330 in which the hydraulic pressure in the actuator chamber 152 is modulated to increase or decrease the frictional engagement between the clutch plates. The degree of frictional engagement between plates corresponds to the capacity of the clutch 124 and associated gears to transfer torque without significant slippage. To modulate the clutch 124, the hydraulic control unit 200 measures or senses the degree of slippage between clutch plates via the clutch sensor 201 and utilizes the information to operate the counter-pressure control valve 192 accordingly. For example, if the hydraulic control unit 200 senses too much slippage, it may increase the hydraulic pressure directed to the counter-pressure control valve 192 to the back chamber 188 of the accumulator 180 thereby displacing the accumulator piston 184 toward the front chamber 186. Displacement of the accumulator piston 184 results in increased hydraulic pressure transmitted to the clutch actuator 124 via the accumulator line 190 thereby causing the actuator piston 154 to force the clutch plates into stronger frictional engagement. Because the clutch plates were already in contact, modulating the clutch 124 requires minimal additional hydraulic flow and the modulating stage 330 is primarily characterized as adjusting the hydraulic fluid pressure in the hydraulic circuit 130 by small displacements of the accumulator piston 184 and the actuator piston 154. During modulation, the on-off valve 172 may be shut off or restricted.

If the hydraulic control unit 200 determines to decrease the torque capacity of the clutch 124, it may reduce the counter-pressure through the counter-pressure control valve 192 thereby relieving the hydraulic pressure on the clutch plates. To reduce the counter-pressure, the counter-pressure control valve 192 may vent or bleed off hydraulic pressure it receives from the hydraulic fluid source 160 or another source. Hence, according to the chart 300, during the modulating stage 330, the counter-pressure control valve 192 is responsible for modulating the clutch actuator pressure 332 by modulating the accumulator pressure 334. Clutch modulation may terminate upon completion of the gear shift when clutch is at full torque capacity. At this stage, the on-off valve 172 may open the clutch actuator to the full hydraulic pressure from the hydraulic fluid source 160.

Hence, the flow rate and pressure modulation of the hydraulic fluid in the hydraulic circuit are the responsibility of different components, namely, the on-off valve 172 and the accumulator 180 respectively, that can be used in combination to conduct different stages of clutch actuation. A possible advantage of the disclosure is that actuation timing of the clutch 124 can be controlled in part by selective sizing and/or rating of the relative capacities of the clutch actuator 126 and the accumulator 180 including the spring constants associated with the actuator spring 159 and the accumulator spring 189. A related possible advantage of the disclosure is the hydraulic circuit is more tolerant to variations or changes in the hydraulic capacities of the clutch actuator 124. Variations caused by dimensional tolerances, fluid leakage, component wear or other reasons can be compensated through adjustment of the counter-pressure control valve 192 using information continuously fed back through the hydraulic control unit 200. These and other advantages of the disclosure will be apparent from the foregoing description and the accompanying drawings.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A hydraulic circuit for a transmission including at least one clutch, the hydraulic circuit comprising:
a hydraulic fluid source supplying pressurized hydraulic fluid;
a clutch operatively associated with a clutch actuator having an actuator chamber and a actuator piston movably disposed in the actuator chamber, the clutch actuator in fluid communication with the hydraulic fluid source;
an on-off valve disposed between the clutch actuator and the hydraulic fluid source and configured to selectively establish fluid communication between the clutch actuator and the hydraulic fluid source;
an accumulator downstream of and in fluid communication with the clutch actuator and hydraulic fluid source; the accumulator adapted to provide a counter-pressure to the clutch actuator.

2. The hydraulic circuit of claim 1, further comprising a counter-pressure control valve operatively associated with the accumulator and operative to modulate the counter-pressure provided by the accumulator.

3. The hydraulic circuit of claim 2, wherein the clutch actuator includes an actuator spring urging the actuator piston against pressurized hydraulic fluid in the actuator chamber and the accumulator includes an accumulator spring urging pressurized hydraulic fluid from the accumulator.

4. The hydraulic circuit of claim 3, wherein the accumulator spring has a spring rate equal to or higher than a spring rate of the actuator spring so that the actuator chamber fills with pressurized hydraulic fluid prior to the accumulator.

5. The hydraulic circuit of claim 4, further comprising a hydraulic control unit in electronic communication with the counter-pressure control valve, the hydraulic control unit configured to modulate the clutch.

6. The hydraulic circuit of claim 5, wherein the accumulator is a double acting cylinder including a front chamber and a back chamber and an accumulator piston movable disposed between the front chamber and the back chamber.

7. The hydraulic circuit of claim 6, wherein the back chamber is in fluid communication with the hydraulic fluid source via the counter-pressure control valve.

8. The hydraulic circuit of claim 1, further comprising a supply restrictor disposed between the hydraulic fluid source and the on-off valve, the supply restrictor configured to determine a fill rate of the actuator chamber.

9. The hydraulic circuit of claim 8, wherein the on-off valve is a three-way valve configured to vent pressurized hydraulic fluid from the clutch actuator and the accumulator to a vented reservoir.

10. The hydraulic circuit of claim 1, wherein the clutch includes a plurality of clutch plates disposed adjacent to and frictionally engagable with each other.

11. A method of engaging a clutch comprising:
opening an on-off valve disposed between hydraulic fluid source and a clutch actuator operatively associated with a clutch;
supplying through the on-off valve a pressurized hydraulic fluid from the hydraulic fluid source to the clutch actuator to fill an actuator chamber of the clutch actuator;
supplying through the on-off valve pressurized hydraulic fluid from the hydraulic fluid source to an accumulator downstream of the clutch to fill an accumulator chamber of the accumulator;
applying a counter-pressure via the accumulator to counter the pressurized hydraulic fluid in the accumulator chamber; and
modulating the counter-pressure to modulate hydraulic pressure of the pressurized hydraulic fluid in the actuator chamber.

12. The method of claim 11, wherein modulating the counter-pressure raises hydraulic pressure in the clutch actuator from a touchup condition of the clutch to a clamped condition of the clutch.

13. The method of claim 12, further comprising urging an actuator piston of the clutch actuator against the actuator chamber to reduce chamber volume; and
urging an accumulator spring into the accumulator chamber.

14. The method of claim 13, wherein the accumulator spring has a spring force equal to or greater than a spring force of an actuator spring disposed in the clutch actuator.

15. The method of claim 14, further comprising continuing supply of the pressurized hydraulic fluid from the hydraulic fluid source to the clutch actuator and the accumulator upon reaching the clamped condition of the clutch.

16. A hydraulic circuit for actuating a clutch comprising:
a clutch actuator operatively associated with the clutch;
a on-off valve in fluid communication with and disposed between the clutch actuator and a hydraulic fluid source supplying pressurized hydraulic fluid, the on-off valve adapted to fill the clutch actuator with pressurized hydraulic fluid; and
an accumulator disposed in parallel to the on-off valve and in fluid communication with the clutch actuator, the accumulator adapted to modulate hydraulic pressure in the clutch actuator.

17. The hydraulic circuit of claim 16, wherein the accumulator provide a counter-pressure to hydraulic pressure in the clutch actuator once the clutch has filled.

18. The hydraulic circuit of claim 17, further comprising a counter-pressure control valve operatively associated with the accumulator and operative to modulate the counter-pressure provided by the accumulator.

19. The hydraulic circuit of claim 16, wherein the clutch actuator is a hydraulic cylinder including an actuator chamber having an actuator piston slidably disposed therein, the actuator chamber in fluid communication with both the on-off valve and the accumulator.

20. The hydraulic circuit of claim 16, wherein the accumulator is a double-acting hydraulic cylinder including an accumulator chamber and an accumulator piston slidably disposed therein, the accumulator piston separating the hydraulic cylinder into a front chamber and a back chamber.
